(19) United States
(12) Patent Application Publication
(10) Pub. No.: US 2005/0185048 A1
(43) Pub. Date: Aug. 25, 2005

(54) 3-D display system, apparatus, and method for reconstructing intermediate-view video

(75) Inventor: Tae-hyeun Ha, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/043,181

(22) Filed: Jan. 27, 2005

(30) Foreign Application Priority Data
Feb. 20, 2004 (KR) 2004-11331

(51) Int. Cl. H04N 13/00

(52) U.S. Cl. 348/42

(57) ABSTRACT

Provided are a method, system, and an apparatus for reconstructing intermediate video using symmetric disparity estimation. A virtual video area is set in an intermediate-view of a left image and a right image, and the virtual video is divided into predetermined block units. A left disparity vector and a right disparity vector are estimated by moving blocks of the left image and right image on a pixel-by-pixel basis symmetrically with respect to reference coordinates of an arbitrary block among the divided block units, and intermediate-view video with pixel values of a left image and a right image are formed from the estimated left disparity vector and right disparity vector.

### BACKGROUND OF THE INVENTION

This application claims priority from Korean Patent Application No. 2004-11331, filed on Feb. 20, 2004, in the Korean Intellectual Property Office, the disclosure of which is incorporated herein in its entirety by reference.

1. Field of the Invention

The present invention relates to an intermediate-view video reconstruction technique, and more particularly, to a method of reconstructing intermediate-view video using symmetric disparity estimation and a 3-dimensional display system using the method.

2. Description of the Related Art

In general, binary disparity enables us to see objects three-dimensionally. Two eyes see images of different views and the brain recognizes three-dimensional objects by synthesizing the difference between those two stereo images. Hitherto, a variety of stereoscopic three-dimensional display systems have been developed in imitation of such human visual systems (HVS). However, since views of these stereoscopic types are limited to two, when observers go beyond the field of view or are out of focus, they cannot feel a cubic effect and eye strain and dizziness may result. For these reasons, actual application of stereoscopic display systems is limited.

To solve disadvantages of conventional stereoscopic display systems, research on various multi-view 3D display systems has been conducted. Since multi-view 3D display systems obtain and display multi-view video through multi-view 3D cameras, the field of view is enlarged and a more natural 3D display can be achieved as the number of views increases. However, the quantity of data for multi-view imaging increases exponentially as the number of views increases, and therefore, real-time image processors and high-speed and broadband transmission channels are required. Recently, to attempt to solve the problem, intermediate video reconstruction (IVR) techniques are being studied and developed, which reconstruct a number of arbitrary multi-view stereo images in a digital manner using a limited number of stereo images. Since the IVR techniques reconstruct arbitrary multi-view stereo images in a digital manner, the problems of conventional 3D display systems can be solved and natural 3D display having the larger field of view can be obtained.

A representative method of implementing IVR utilizes MPEG1/2 motion estimation and motion compensation, in which a disparity in view between an image of one view and an image of an adjacent view is estimated and a new image is reconstructed at a location corresponding to an intermediate disparity among estimated disparities. In general, disparity estimation (DE) in IVR is classified into pixel-based DE and block-based DE.

FIG. 1 shows an example of IVR according to block-based DE.

First, a left image is divided into NXN blocks. Among blocks of a right image, the most similar block with respect to each block of the left image is estimated using a sum of absolute difference (SAD) or a mean absolute difference (MAD). At this time, the distance between a reference block and an estimated block is defined as a disparity vector (DV). In general, the DV can be separately given to every pixel within a reference image.

Thus, an intermediate video is created with averages of each pixel of the left image and each pixel of the right image which is matched to each pixel of the left image. In other words, a pixel of the intermediate video can be expressed as follows.

$${I}_{i} ( x + DV ( x , y ) / 2 , y ) = \frac{{I}_{l} ( x , y ) + {I}_{r} ( x + DV ( x , y ) , y )}{2} , \qquad ( 1 )$$

where Iᵢ represents a pixel value of the intermediate video, Iₗ represents a pixel value of the left image, and Iᵣ represents a pixel value of the right image.

However, conventional block-based DE performs searches on the number of pixels in a horizontal axis of an image to be estimated on a pixel-by-pixel basis. Also, due to an occlusion area between the left image and the right image, holes (indicated by black blocks) are caused in the intermediate video, as shown in FIG. 2.

### SUMMARY OF THE INVENTION

The present invention provides a system, method and an apparatus for reconstructing intermediate-view video using symmetric disparity estimation.

According to one aspect of the present invention, there is provided a method of reconstructing intermediate-view video. The method comprises setting a virtual video area in an intermediate-view of a left image and a right image, dividing virtual video into predetermined block units, estimating a left disparity vector and a right disparity vector by moving blocks of the left image and right image on a pixel-by-pixel basis symmetrically with respect to reference coordinates of an arbitrary block among the divided block units, and creating the intermediate-view video with pixel values of a left image and a right image from the estimated left disparity vector and right disparity vector.

According to another aspect of the present invention, there is provided a 3-dimensional display system comprising a stereo image input means for inputting a stereo image pair divided into a left image and a right image and an intermediate video reconstruction means for setting virtual video in an intermediate-view of the left image and right image that are output from the stereo image input means and creating intermediate video by symmetrically matching a left image and a right image of the virtual video.

The IVR means comprises a buffer unit, a virtual video processing unit, a disparity vector processing unit, and an intermediate video creating unit. The buffer unit stores the stereo image pair divided into the left image and the right image on a frame-by-frame basis. The virtual video processing unit sets a virtual video area in the intermediate view of the left image and right image stored in the buffer unit and divides the virtual video into predetermined block units. The disparity vector processing unit estimates a disparity vector by moving blocks of the left image and right image, stored in the buffer unit, on a pixel-by-pixel basis symmetrically with respect to reference coordinates of an arbitrary block among the block units divided by the virtual video processing unit. The intermediate video creating unit creates intermediate video with pixel values of a left image and a right image from the disparity vector estimated by the disparity vector estimation unit.

### BRIEF DESCRIPTION OF THE DRAWINGS

The above and other aspects of the present invention will become more apparent by describing in detail exemplary embodiments thereof with reference to the attached drawings in which:

FIG. 1 shows a prior art example of IVR according to block-based DE;

FIG. 2 shows an intermediate image signal reconstructed through conventional DE;

FIG. 3 is a flowchart illustrating a method of reconstructing intermediate-view video using symmetric DE according to an exemplary embodiment of the present invention;

FIG. 4 is a conceptual view showing IVR using symmetric DE according to an exemplary embodiment of the present invention;

FIG. 5 shows an image reconstructed by adopting a method of reconstructing intermediate-view video according to an exemplary embodiment of the present invention;

FIG. 6 is a block diagram of an apparatus for reconstructing intermediate-view video according to an exemplary embodiment of the present invention; and

FIG. 7 is a detailed block diagram of the apparatus for reconstructing intermediate-view video of FIG. 6 according to an exemplary embodiment of the present invention.

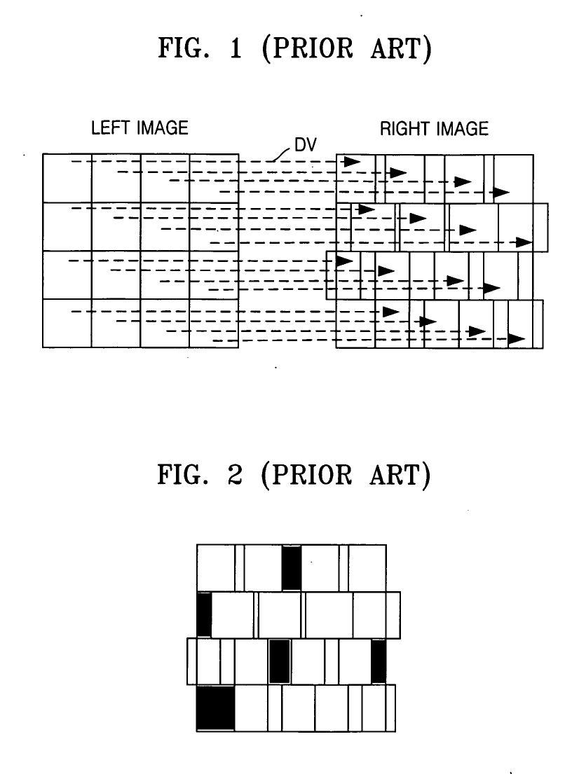

### DETAILED DESCRIPTION OF EXEMPLARY EMBODIMENTS OF THE INVENTION

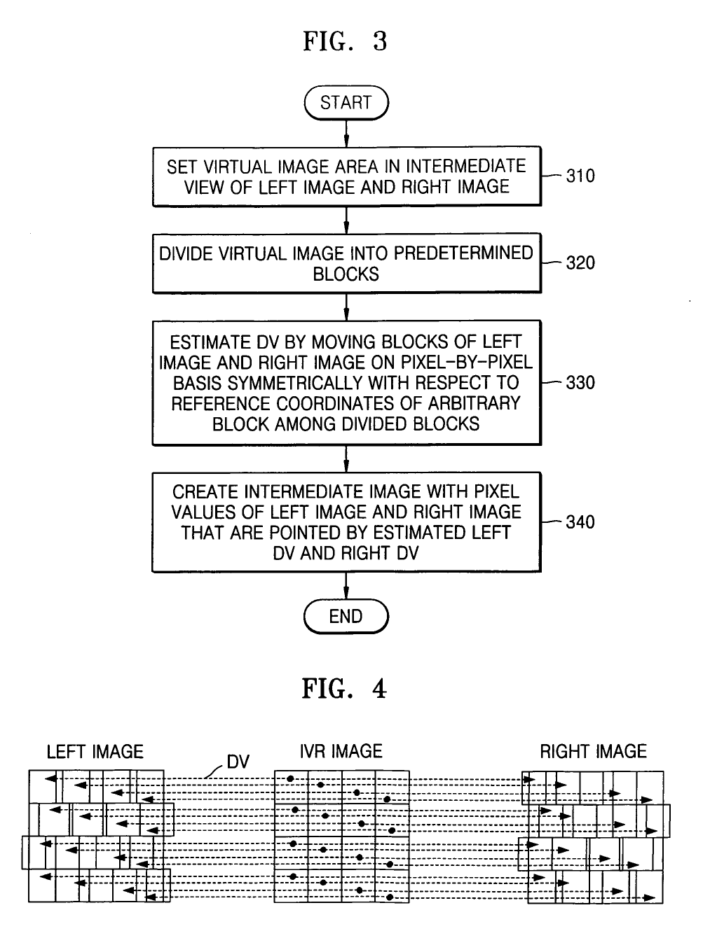

FIG. 3 is a flowchart illustrating a method of reconstructing intermediate-view video using symmetric DE according to an exemplary embodiment of the present invention. The present invention will be described with reference to a conceptual view showing IVR using symmetric DE shown in FIG. 4.

First, stereo video that is classified into a left image and a right image is stored on a frame-by-frame basis.

In operation 310, a virtual image area is set in an intermediate view of the left image and right image.

In operation 320, a virtual image area is divided into predetermined blocks.

In operation 330, a DV is estimated by moving blocks of the left image and right image on a pixel-by-pixel basis symmetrically with respect to reference coordinates of an arbitrary block among the divided blocks. After SAD values between the reference blocks within the virtual video and the reference blocks within search areas of the left image and right image are calculated, the DV is determined to be a spatial distance to a block having a minimum SAD. Thus, the DV indicates a distance between blocks of the left image and right image that are matched with blocks of a virtual intermediate image symmetrically. Hereinafter, DV estimation will be described. First, the SAD is calculated as follows.

$${SAD}_{( k , l )} ( x , y ) = {\sum }_{i = 1}^{{N}_{1}} {\sum }_{j = 1}^{{N}_{2}} \vert {I}_{l} ( k + i - x , l + j + y ) - \\ {I}_{r} ( k + i + x , l + j + y ) \vert , \qquad ( 2 )$$

where Iᵢ and Iᵣ represent a pixel value of the left image and a pixel value of the right image, respectively; (i, j) represents a variable indicating spatial coordinates of pixels; (x, y) represents a variable indicating a spatial distance between two matched blocks; (k, l) represents a variable indicating spatial coordinates of two blocks composed of N₁×N₂ pixels; and N_{1 and N}₂ represent a horizontal size and a vertical size of the two matched blocks, respectively.

A DV for the block having the minimum SAD is obtained within an estimated area as follows.

$${( {x}_{m} , {y}_{m} )}_{( k , l )} = arg {min}_{( x , y ) ∈ S} \{ {SAD}_{( k , l )} ( x , y ) \} , \qquad ( 3 )$$

where S represents a search range for DE and (xₘ, yₘ) represents a disparity vector for the block having the minimum SAD. At this time, in IVR, there exits a horizontal direction disparity due to a structure of an image input device, but there is little vertical direction disparity. As a result, a vertical component, i.e., y, is typically set to 0, or if there is a vertical direction disparity, the vertical component may be set in the range of plus or minus 1 to plus or minus 2.

Eventually, a block of the virtual image is estimated by matching a block of the left image with a block of the right image.

In operation 340, intermediate video is created with pixel values of the left image and right image that are pointed by estimated left DV and right DV (−DV and +DV). In other words, as indicated in Equation 4, virtual video is determined in an intermediate-view of the left image and right image. Once a left DV and a right DV that face the left image and the right image with respect to the virtual image are given, an intermediate image is created with pixel averages of the left image and right image that are pointed by the left DV and the right DV. For example:

$${I}_{i} ( x , y ) = \frac{{I}_{l} ( x - DV ( x , y ) / 2 , y ) + {I}_{r} ( x + DV ( x , y ) / 2 , y )}{2} , \qquad ( 4 )$$

where Iᵢ represents a pixel value of the intermediate image, Iₗ represents a pixel value of the left image, Iᵣ represents a pixel value of the right image, and DV(x, y) represents a variable indicating a spatial distance between two matched blocks.

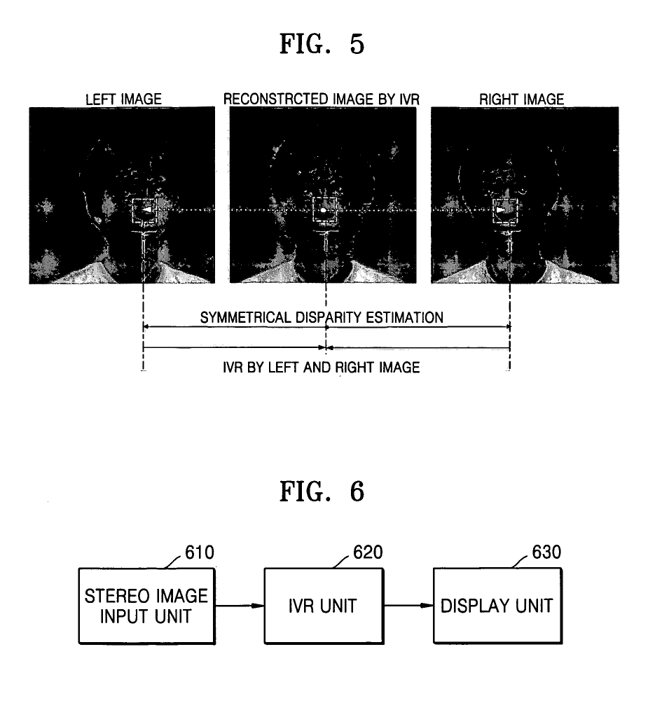

FIG. 5 shows an image reconstructed by applying a method of reconstructing intermediate-view video according to an exemplary embodiment of the present invention.

Referring to FIG. 5, symmetric DE is carried out between a left image and a right image as a stereo pair, thereby reconstructing an intermediate image.

FIG. 6 is a block diagram of an apparatus for reconstructing intermediate-view video according to an exemplary embodiment of the present invention.

A stereo image input unit 610 inputs a stereo image pair that is divided into a left image and a right image.

An IVR unit 620 sets a virtual video in an intermediate view of the left image and right image that are output from the stereo image input unit 610 and creates an intermediate image by symmetrically referring to a left image and a right image with respect to the virtual intermediate image.

A display unit 630 displays the intermediate video created by the IVR unit 620 using, for example, a cathode ray tube (CRT).

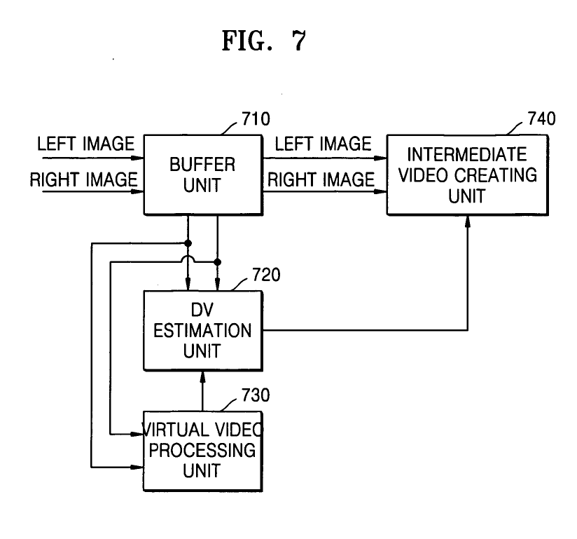

FIG. 7 is a detailed block diagram of the apparatus for reconstructing intermediate-view video of FIG. 6 according to an exemplary embodiment of the present invention.

As shown in FIG. 7, a buffer unit 710 stores a stereo pair image, which is divided into a left image and a right image, on a frame-by-frame basis.

A virtual video processing unit 730 sets a virtual image area in an intermediate view of the left image and right image that are stored in the buffer unit 710 and divides the virtual image into predetermined block units.

A DV estimation unit 720 estimates a left DV and a right DV by moving blocks of the left image and right image, which are stored in the buffer unit 710, on a pixel-by-pixel basis symmetrically with respect to reference coordinates of an arbitrary block among the blocks divided by the virtual video processing unit 730.

An intermediate video creating unit 740 creates an intermediate image with pixel averages of the left image and right image that are pointed by the left DV and the right DV as estimated by the DV estimation unit 720.

As described above, according to the present invention, by performing symmetric DE with reference to both a left image and a right image of a virtual intermediate image, it is possible to reduce the complexity of DVs. Additionally, the present invention's application of a symmetric DE for intermediate video reconstruction prevents holes that are frequently generated by conventional DE.

The above-identified invention may be embodied in a computer program product, as will now be explained.

On a practical level, the software that enables a computer system to perform the operations described above may be supplied on any one of a variety of media. Furthermore, the actual implementation of the approach and operations of the invention are actually statements written in a programming language. Such programming language statements, when executed by a computer, cause a computer to act in accordance with the particular content of the statements. Furthermore, software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include a diskette, a tape, a compact disc, an integrated circuit, a ROM, a CD, a cartridge, a memory stick, a card, a remote transmission via a communications circuit, or any other similar medium useable by computers known now or developed hereafter. For example, to supply software for enabling a computer system to operate in accordance with the invention, the supplier might provide a diskette or might transmit the software in some form via satellite transmission, via a direct telephone link, or via the Internet. Thus, the term, “computer readable medium” is intended to include the entire foregoing and any other medium by which software may be provided to a computer.

Although the enabling software might be “written on” a diskette, “stored in” an integrated circuit, or “carried over” a communications circuit, it will be appreciated that, for the purposes of this application, the software will be referred to as being “on” the computer readable medium. Thus, the term “on” is intended to encompass the above and all equivalent ways in which software is or can be associated with a computer readable medium.

For the sake of simplicity, therefore, the term “program product” is thus used to refer to a computer readable medium, as defined above, which bears, in any form, software to enable a computer system to operate according to the above-identified invention. Thus, the invention is also embodied in a program product bearing software which enables a computer to perform according to the invention.

The invention is also embodied in a user interface invocable by an application program. A user interface may be understood to mean any hardware, software, or combination of hardware and software that allows a user to interact with a computer system. For the purposes of this discussion, a user interface will be understood to include one or more user interface objects. User interface objects may include display regions, user activatable regions, and the like.

As is well understood, a display region is a region of a user interface which displays information to the user. A user activatable region is a region of a user interface, such as a button or a menu, which allows the user to take some action with respect to the user interface.

A user interface may be invoked by an application program. When an application program invokes a user interface, it is typically for the purpose of interacting with a user. It is not necessary, however, for the purposes of this invention that an actual user ever interact with the user interface. It is also not necessary, for the purposes of this invention, that the interaction with the user interface be performed by an actual user. That is to say, it is foreseen that the user interface may have interaction with another program, such as a program created using macro programming language statements that simulate the actions of a user with respect to the user interface.

As described above, by adopting calculation of an absolute difference value according to the present invention, it is possible to reduce the number of adders used for calculation of an absolute difference value, thereby alleviating the load on: the apparatus for calculating the absolute difference value, the motion estimation apparatus, and the motion picture encoding apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of reconstructing intermediate-view video, the method comprising:
setting a virtual image area in an intermediate-view of a left image and a right image;
dividing the virtual image area into predetermined block units;
estimating a left disparity vector and a right disparity vector by moving blocks of the left image and right image on a pixel-by-pixel basis symmetrically with respect to reference coordinates of an arbitrary block among the divided block units; and
creating an intermediate-view image with pixel values of the left image and the right image that are pointed by the estimated left disparity vector and the estimated right disparity vector.

2. The method of claim 1, wherein creating the intermediate-view image comprises creating a pixel value of the intermediate-view image with pixel averages of the left image and the right image that are pointed by the left disparity vector and the right disparity vector.

3. The method of claim 1, wherein estimating the left disparity vector and the right disparity vector includes:
calculating sum of absolute difference (SAD) values between a reference block of the virtual image area and reference blocks of the left image and right image; and
determining a minimum SAD value among the calculated SAD values to be a disparity vector.

4. The method of claim 3, wherein the SAD values are calculated as follows:
$${SAD}_{( k , l )} ( x , y ) = {\sum }_{i = 1}^{{N}_{1}} {\sum }_{j = 1}^{{N}_{2}} \vert {I}_{l} ( k + i - x , l + j + y ) - \\ {I}_{r} ( k + i + x , l + j + y ) \vert ,$$
where Iᵢ and Iᵣ represent a pixel value of the left image and a pixel value of the right image, respectively; (i, j) represents a variable indicating spatial coordinates of pixels; (x, y) represents a variable indicating a spatial distance between two matched blocks; (k, l) represents a variable indicating spatial coordinates of two blocks composed of N₁×N₂ pixels; and N₁ and N₂ represent a horizontal size and a vertical size of the two matched blocks, respectively.

5. The method of claim 3, wherein the disparity vector for a block having the minimum SAD value is obtained as follows:
$${( {x}_{m} , {y}_{m} )}_{( k , l )} = arg {min}_{( x , y ) ∈ S} \{ {SAD}_{( k , l )} ( x , y ) \} ,$$
where S represents a search range for a disparity estimate (DE) and (xₘ, yₘ) represents the disparity vector for the block having the minimum SAD.

6. The method of claim 1, wherein a pixel value of the intermediate-view image is given by:
$${I}_{i} ( x , y ) = \frac{{I}_{l} ( x - DV ( x , y ) / 2 , y ) + {I}_{r} ( x + DV ( x , y ) / 2 , y )}{2} ,$$
where Iᵢ represents the pixel value of the intermediate-view image, Iₗ represents a pixel value of the left image, Iᵣ represents a pixel value of the right image, and DV(x, y) represents a variable indicating a spatial distance between two matched blocks.

7. A three-dimensional display system comprising:
a stereo image input unit which inputs a stereo image pair divided into a left image and a right image; and
an intermediate image reconstruction (IVR) unit which sets a virtual video area in an intermediate-view of the left image and right image that are output from the stereo image input means and creates intermediate-view video by symmetrically matching a left image and a right image of the virtual video area.

8. The three-dimensional display system of claim 7, wherein the IVR unit comprises:
a buffer unit which stores the stereo image pair divided into the left image and the right image on a frame-by-frame basis;
a virtual video processing unit which sets the virtual image area in the intermediate view of the left image and right image stored in the buffer unit and divides the virtual image area into predetermined block units;
a disparity vector processing unit which estimates a disparity vector by moving blocks of the left image and right image, stored in the buffer unit, on a pixel-by-pixel basis symmetrically with respect to reference coordinates of an arbitrary block among the block units divided by the virtual video processing unit; and
an intermediate video creating unit which creates intermediate image with pixel values of a left image and a right image that are pointed by the disparity vector estimated by the disparity vector estimation unit.

9. The system of claim 8, wherein the disparity vector processing unit includes:
a calculator that calculates sum of absolute difference (SAD) values between a reference block of the virtual image area and reference blocks of the left image and right image; and
a determination unit that determines a minimum SAD value among the calculated SAD values for a disparity vector.

10. The system of claim 9, wherein the SAD values are calculated as follows:
$${SAD}_{( k , l )} ( x , y ) = {\sum }_{i = 1}^{{N}_{1}} {\sum }_{j = 1}^{{N}_{2}} \vert {I}_{l} ( k + i - x , l + j + y ) - \\ {I}_{r} ( k + i + x , l + j + y ) \vert ,$$
where Iᵢ and Iᵣ represent a pixel value of the left image and a pixel value of the right image, respectively; (i, j) represents a variable indicating spatial coordinates of pixels; (x, y) represents a variable indicating a spatial distance between two matched blocks; (k, l) represents a variable indicating spatial coordinates of two blocks composed of N₁×N₂ pixels; and N₁ and N₂ represent a horizontal size and a vertical size of the two matched blocks, respectively.

11. The system of claim 9, wherein the disparity vector for a block having the minimum SAD value is obtained as follows:
$${( {x}_{m} , {y}_{m} )}_{( k , l )} = arg {min}_{( x , y ) ∈ S} \{ {SAD}_{( k , l )} ( x , y ) \} ,$$
where S represents a search range for a disparity estimate (DE) and (xₘ, yₘ) represents a disparity vector for a block having the minimum SAD.

12. The system of claim 7, wherein a pixel value of the intermediate-view video is given by:
$${I}_{i} ( x , y ) = \frac{{I}_{l} ( x - DV ( x , y ) / 2 , y ) + {I}_{r} ( x + DV ( x , y ) / 2 , y )}{2} ,$$
where Iᵢ represents a pixel value of the intermediate-view image, Iₗ represents a pixel value of the left image, Iᵣ represents a pixel value of the right image, and DV(x, y) represents a variable indicating a spatial distance between two matched blocks.

13. A computer readable recording medium having recorded thereon computer readable instructions for causing a computer to implement a method of reconstructing intermediate-view video, the method comprising:
setting a virtual image area in an intermediate-view of a left image and a right image;
dividing the virtual image area into predetermined block units;
estimating a left disparity vector and a right disparity vector by moving blocks of the left image and right image on a pixel-by-pixel basis symmetrically with respect to reference coordinates of an arbitrary block among the divided block units; and
creating an intermediate-view image with pixel values of the left image and the right image that are pointed by the estimated left disparity vector and the estimated right disparity vector.

14. A computer readable recording medium having recorded thereon computer readable instructions for causing a computer to implement method of claim 13, wherein creating the intermediate-view image comprises creating a pixel value of the intermediate-view image with pixel averages of the left image and the right image that are pointed by the left disparity vector and the right disparity vector.

15. A computer readable recording medium having recorded thereon computer readable instructions for causing a computer to implement the method of claim 13, wherein estimating the left disparity vector and the right disparity vector includes:
calculating sum of absolute difference (SAD) values between a reference block of the virtual image area and reference blocks of the left image and right image; and
determining a minimum SAD value among the calculated SAD values to be a disparity vector.

16. A computer readable recording medium having recorded thereon computer readable instructions for causing a computer to implement the method of claim 15, wherein the SAD values are calculated as follows:
$${SAD}_{( k , l )} ( x , y ) = {\sum }_{i = 1}^{{N}_{1}} {\sum }_{j = 1}^{{N}_{2}} \vert {I}_{l} ( k + i - x , l + j + y ) - {I}_{r} ( k + i + x , l + j + y ) \vert ,$$
where Iᵢ and Iᵣ represent a pixel value of the left image and a pixel value of the right image, respectively; (i, j) represents a variable indicating spatial coordinates of pixels; (x, y) represents a variable indicating a spatial distance between two matched blocks; (k, l) represents a variable indicating spatial coordinates of two blocks composed of N₁×N₂ pixels; and N₁ and N₂ represent a horizontal size and a vertical size of the two matched blocks, respectively.

17. A computer readable recording medium having recorded thereon computer readable instructions for causing a computer to implement the method of claim 15, wherein the disparity vector for a block having the minimum SAD value is obtained as follows:
$${( {x}_{m} , {y}_{m} )}_{( k , l )} = arg {min}_{( x , y ) ∈ S} \{ {SAD}_{( k , l )} ( x , y ) \} ,$$
where S represents a search range for a disparity estimate (DE) and (xₘ, yₘ) represents the disparity vector for the block having the minimum SAD.

18. A computer readable recording medium having recorded thereon computer readable instructions for causing a computer to implement the method of claim 13, wherein a pixel value of the intermediate-view image is given by:
$${I}_{i} ( x , y ) = \frac{{I}_{l} ( x - DV ( x , y ) / 2 , y ) + {I}_{r} ( x + DV ( x , y ) / 2 , y )}{2} ,$$
where Iᵢ represents the pixel value of the intermediate-view image, Iₗ represents a pixel value of the left image, Iᵣ represents a pixel value of the right image, and DV(x, y) represents a variable indicating a spatial distance between two matched blocks.
